(19) United States
(12) Patent Application Publication
(10) Pub. No.: US 2006/0277546 A1
(43) Pub. Date: Dec. 7, 2006

(54) Detecting virtualization

(76) Inventors: Michael A. Rothman, Puyallup, WA (US); Vincent J. Zimmer, Federal Way, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 11/144,527

(22) Filed: Jun. 2, 2005

(51) Int. Cl. G06F 9/46

(52) U.S. Cl. 718/103

(57) ABSTRACT

In a program executing on a processor based system, obtaining one or more samples of the frequency at which a processor of the system is executing, comparing each sample to at least one of a predetermined set of frequencies and determining whether the program is executing on a virtual machine based at least in part on of the result of the comparing

### BACKGROUND

A processor may be used in a processor based system such as a computer, including a desktop, server, workstation, or notebook computer; in a hand held device such as a personal digital assistant or PDA, “smart” mobile phone, or portable game system; or in a game console or station, set-top box, or other home entertainment device, among others. In each case, a processor operates based on a basic execution cycle, and one processor parameter is the frequency at which the processor cycles occur. This frequency is measured in cycles per second, or hertz (Hz), or multiples thereof such as megahertz (MHz) and gigahertz (GHz).

In some cases, a processor may be operable at multiple frequencies, e.g. when in a power saving mode, the processor may switch to a mode of operation at a lower frequency than that used when it is in a high performance mode. The set of different frequencies at which a processor may operate in different modes is usually a set of discrete values specified by the manufacturer of the processor.

In some cases, a processor manufacturer may provide a way for a program executing on the processor to determine the specified frequency or frequencies at which the processor is intended to operate. For example, a program may execute an instruction that causes the processor to return a model number based on which the program may determine, by accessing a stored table, a corresponding frequency or frequencies at which the processor may operate.

Processor based systems may also provide a real time clock. Programs executing on such a system may have access to the real time clock, and be able to use it to programmatically determine a real time period during program execution, such as by causing the program to suspend for a specific time as measured by the real time clock.

Virtualization is a technique that enables a processor based host machine with support for virtualization in hardware and software, or in some cases, in software only, to present an abstraction of the host, such that the underlying hardware of the host machine appears as one or more independently operating virtual machines. Each virtual machine may therefore function as a self-contained platform. Often, virtualization technology is used to allow multiple guest operating systems and/or other guest software to coexist and execute apparently simultaneously and apparently independently on multiple virtual machines while actually physically executing on the same hardware platform. A virtual machine may mimic the hardware of the host machine or alternatively present a different hardware abstraction altogether.

Virtualization systems provide guest software operating in a virtual machine with a set of resources (e.g., processors, memory, IO devices) and may map some or all of the components of a physical host machine into the virtual machine, or create fully virtual components. The virtualization system may thus be said to provide a “virtual bare machine” interface to guest software.

### BRIEF DESCRIPTION OF THE DRAWINGS

FIG. 1 is a high level block diagram of a virtualized environment in one embodiment.

FIG. 2 is a high level flow diagram of the operation of a virtualized environment in one embodiment.

FIG. 3 is a high level flow diagram of processing in an embodiment.

FIG. 4 is a high level flow diagram of processing in an embodiment.

### DETAILED DESCRIPTION

In some embodiments, virtualization systems may include a virtual machine monitor (VMM) which controls the host machine. The VMM provides guest software operating in a virtual machine (VM) with a set of resources such as processors, memory, and IO devices. The VMM may map some or all of the components of a physical host machine into the virtual machine, and may create fully virtual components, emulated in software in the VMM, which are included in the virtual machine (e.g., virtual IO devices). The VMM uses facilities in a hardware virtualization architecture to provide services to a virtual machine and to provide protection from and between multiple virtual machines executing on the host machine.

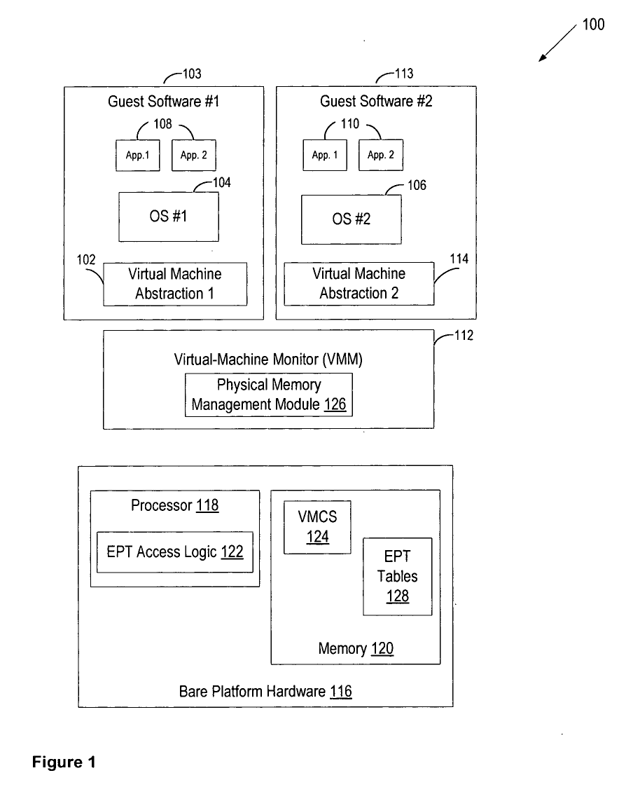

FIG. 1 illustrates one embodiment of a virtual-machine environment 100. In this embodiment, a processor-based platform 116 may execute a VMM 1 12. The VMM, though typically implemented in software, may emulate and export a virtual bare machine interface to higher level software. Such higher level software may comprise a standard OS, a real time OS, or may be a stripped-down environment with limited operating system functionality and may not include OS facilities typically available in a standard OS in some embodiments. Alternatively, for example, the VMM 112 may be run within, or using the services of, another VMM. VMMs may be implemented, for example, in hardware, software, firmware or by a combination of various techniques in some embodiments.

The platform hardware 116 may be a personal computer (PC), mainframe, handheld device such as a personal digital assistant (PDA) or “smart” mobile phone, portable computer, set top box, or another processor-based system. The platform hardware 116 includes at least a processor 118 and memory 120. Processor 118 may be any type of processor capable of executing programs, such as a microprocessor, digital signal processor, microcontroller, or the like. The processor may include microcode, programmable logic or hard coded logic for execution in embodiments. Although FIG. 1 shows only one such processor 118, there may be one or more processors in the system in an embodiment. Additionally, processor 118 may include multiple cores, support for multiple threads, or the like. Memory 120 can comprise a hard disk, a floppy disk, random access memory (RAM), read only memory (ROM), flash memory, any combination of the above devices, or any other type of machine medium readable by processor 118 in various embodiments. Memory 120 may store instructions and/or data for performing program execution and other method embodiments.

The VMM 112 presents to guest software an abstraction of one or more virtual machines, which may provide the same or different abstractions to the various guests. FIG. 1 shows two virtual machines, 102 and 114. Guest software such as guest software 103 and 113 running on each virtual machine may include a guest OS such as a guest OS 104 or 106 and various guest software applications 108 and 110. Guest software 103 and 113 may access physical resources (e.g., processor registers, memory and I/O devices) within the virtual machines on which the guest software 103 and 113 is running and to perform other functions. For example, the guest software 103 and 113 expects to have access to all registers, caches, structures, I/O devices, memory and the like, according to the architecture of the processor and platform presented in the virtual machine 102 and 114.

In one embodiment, the processor 118 controls the operation of the virtual machines 102 and 114 in accordance with data stored in a virtual machine control structure (VMCS) 124. The VMCS 124 is a structure that may contain state of guest software 103 and 113, state of the VMM 112, execution control information indicating how the VMM 112 wishes to control operation of guest software 103 and 113, information controlling transitions between the VMM 112 and a virtual machine, etc. The processor 118 reads information from the VMCS 124 to determine the execution environment of the virtual machine and to constrain its behavior. In one embodiment, the VMCS 124 is stored in memory 120. In some embodiments, multiple VMCS structures are used to support multiple virtual machines.

Resources that can be accessed by guest software (e.g., 103, including guest OS 104 and application 108) may either be classified as “privileged” or “non-privileged.” For privileged resources, the VMM 112 facilitates functionality desired by guest software while retaining ultimate control over these privileged resources. Further, each guest software 103 and 113 expects to handle various platform events such as exceptions (e.g., page faults, general protection faults, etc.), interrupts (e.g., hardware interrupts, software interrupts), and platform events (e.g., initialization (INIT) and system management interrupts (SMIs)). Some of these platform events are “privileged” because they must be handled by the VMM 112 to ensure proper operation of virtual machines 102 and 114 and for protection from and among guest software. Both guest operating system and guest applications may attempt to access privileged resources and both may cause or experience privileged events. Privileged platform events and access attempts to privileged resources are collectively referred to as “privileged events’ or ‘virtualization events” herein.

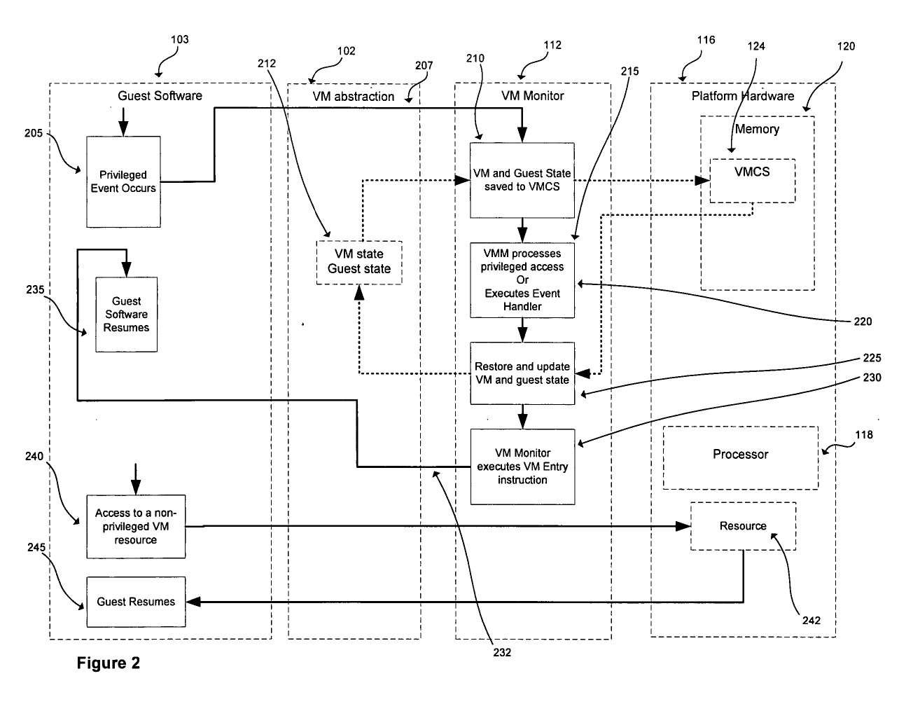

Operation of a virtual machine environment in an embodiment such as that previously described and depicted in FIG. 1 is depicted by processing shown in FIG. 2. FIG. 2 depicts the operation of a VM environment in an embodiment to process a privileged event occurring in guest software; and the operation of the embodiment to process a non-privileged event by guest software. FIG. 2 does not depict all components or all operations that may occur in an environment such as that depicted in FIG. 1. This is solely for clarity of presentation. While a small set of components and a few specific operations are represented in FIG. 2, a VM environment in an embodiment may comprise many other components, and many other operations may take place in such an embodiment.

FIG. 2 depicts one exemplary set of operations of guest software 103 executing on a virtual machine abstraction 102, and platform hardware 116 previously described in FIG. 1. The operations are depicted within blocks indicating where in the system (e.g. in the VMM 112, in the guest software 103, etc.) they occur. In addition to other components of the VM environment previously described, VM abstraction 102 may store a virtual machine state and other state information for the guest software 103 at 212 and may also provide other resources such as a virtual network connection or set of general registers, to name two of many examples, to guests. Of course, the physical resources that implement VM state, guest state, and other VM resources are actually provided by the platform hardware 116 on which the VM executes. The platform hardware includes memory 120, VMCS 124 and processor 118.

At 240, guest software 103 accesses a non-privileged resource 242. Non-privileged resources do not need to be controlled by the VMM 112 and can be accessed directly by guest software which continues without invoking the VMM 112, allowing the guest to continue operation at 245 after accessing the non-privileged resource 242. A non-privileged platform event would likewise be handled without the intervention of the VMM 112 (this is not shown in FIG. 2).

At 205, the guest software 103 attempts to access a privileged resource, and/or experiences a privileged platform event. When such a privileged event occurs as at 205, control may-be transferred 207 to the VMM 112. The transfer of control 207 from guest software to the VMM 112 is referred to herein as a virtual machine exit. After facilitating the resource access or otherwise handling the privileged event appropriately, the VMM 112 may return control to guest software as at 232 which then resumes operation, 235. The transfer of control 232 from the VMM 112 to guest software is referred to as a virtual machine entry. In one embodiment, the VMM 112 initiates a virtual machine entry by executing an instruction specially designed to trigger the transition, 230, referred to herein as a virtual machine entry instruction.

In one embodiment, when a virtual machine exit occurs, components of the processor state used by guest software are saved, 210, components of the processor state required by the VMM 112 are loaded, and the execution resumes in the VMM 112 at 220. In one embodiment, the components of the processor state used by guest software are stored in a guest-state area of VMCS 124 and the components of the processor state required by the VMM 112 are stored in a monitor-state area of VMCS 124. In one embodiment, when a transition from the VMM 112 to guest software occurs, components of the processor state that were saved at the virtual machine exit (and may have been modified by the VMM 112 while processing the virtual machine exit) are restored 225 and control is returned to the virtual machine 102 or 114 at 230.

In other embodiments, the structure of the VM and the organization of the support for guest software may differ. Software that executes on the host machine to support virtualization may or may not be termed a VMM; in some instances, a virtual machine support system may not have hardware components or support. In yet other embodiments, the entire VMM and a guest may run within an executing operating system, unlike the structures depicted in FIG. 1. Many other implementations of virtual machines are possible as is known in the art.

When a VMM supported by hardware implements a VM as above in an embodiment as described with reference to FIGS. 1 and 2, a program executing within the VM may be presented with a virtualized guest machine environment that is indistinguishable in many respects from a physical machine environment. With hardware support, the VMM may trap and correctly handle special instructions such as accesses to privileged resources such as model specific registers of the virtual processor, returning values as would be returned by a physical processor; furthermore, privileged accesses to hardware e.g. memory accesses with side effects on I/O devices, may be properly simulated in the embodiment by the described operation of the VMM and the VMCS in conjunction with virtualization support in the hardware in the embodiment. Specifically, in one instance, a particular platform may provide VM that presents virtual hardware that is in many respects similar to or identical to the underlying physical hardware, e.g. by providing a virtual processor that is the same processor type and model as the underlying physical processor, the same I/O devices as those connected to the buses of the physical machine, etc. Platform or processor-specific references to the processor or other hardware made by a guest may then be passed to the physical platform and the VM via the intermediary VMM and VMCS for a proper response, thus providing an environment to the guest that is a close replica of the underlying physical hardware. This makes it very hard for the guest to be able to detect the existence of the intervening virtualization.

Alternatively, the VMM and the virtualization support system may provide an environment based on a processor or platform that is different from the underlying physical system. Even in this case, a careful implementation of the virtualization subsystem and VMM may prevent a program executing on the virtual machine from detecting the virtualized nature of the environment by any straightforward method.

In some situations, it may be important for a program to be aware of the virtualized nature of the environment in which it is executing. For example, it may be necessary for a program vendor who wishes to have proper operation of a performance critical program to ensure that the program is only installed on physical hardware with certain minimum capabilities, such as minimum memory size or processor frequency. In a virtualized environment, a VM may report memory size or processor frequency, or other parameters of the virtualized hardware, which may not accurately reflect the actual capabilities of the underlying hardware. Moreover, the execution of a program within a VM generally incurs an overhead merely due to the operation of the VM itself, and this overhead may be undesirable for some performance critical processing in programs. Other programs such as those manipulating or displaying secured data may wish to authenticate hardware devices or run only on an approved hardware platform. If the platform on which such a program executed were to actually be a VM executing on an unapproved platform and maliciously designed to simulate an approved physical hardware platform, the security of such a program might be compromised if it were impossible for the program to detect that the platform on which the program was executing was virtualized.

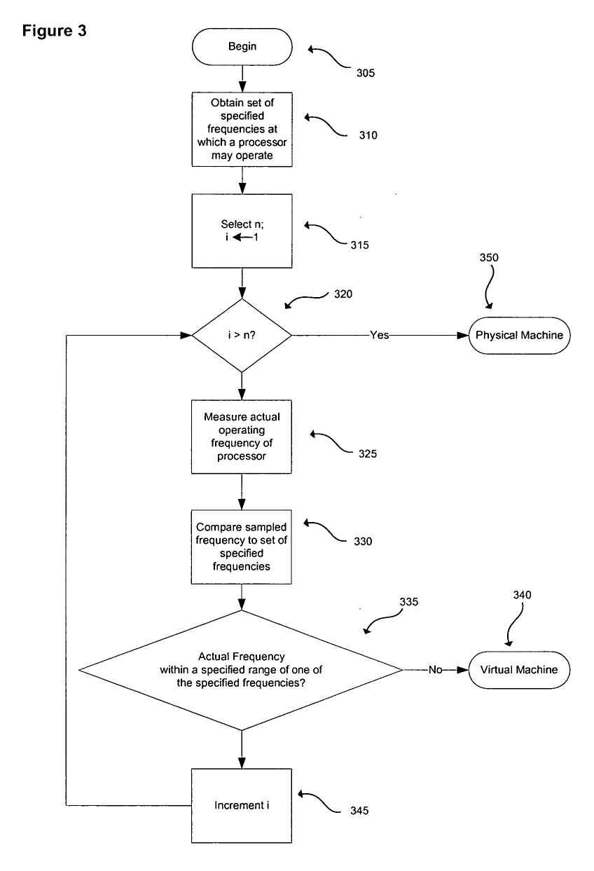

A process for a program to detect that it is running on a virtualized embodiment is depicted in FIG. 3. In FIG. 3, one or more iterations of a comparison process between the measured operating frequency of a processor and its specified set of valid operating frequencies occur in one embodiment. At the start of the process, 305, a set of the valid specified frequencies at which the processor may operate is obtained, 310. In an iterative manner, with i representing a loop variable in the flowchart, starting at 1 at 315, and limited by some number n by the exit at 320, n comparisons of measured and specified frequencies are made. As is known, any manner of iteration may be used that is equivalent to the basic loop shown. In some instances, the loop may be omitted, i.e. when n is 1.

Determination of the processor frequency is known in the art, as is determination of the specified frequencies at which a processor may operate. In each iteration, the actual frequency of the processor is measured, 325, then the measured value is compared to the set of specified valid frequencies, 330. The result of the comparison is evaluated, 335. If any of the comparisons falls outside a normal tolerance range for frequencies as specified, the machine is a virtual machine, and the process is complete at 340. Otherwise, the loop repeats, 345, with an incremented value for the loop counter. If all n tests have completed without an out-of-range measurement, that is, the loop exits at 320, this implies a result that indicates that the process is executing on a physical machine, and not on a virtual machine, at 350.

In one embodiment, virtualization is implemented using internal architectural support and a VMM on an Intel® Architecture processor such the IA-32 Intel® Architecture platform (IA-32), which is described in the IA-32 Intel® Architecture Software Developer's Manual (IA-32 documentation). In one embodiment, both the virtualized processor and the underlying physical processor are IA-32 processors, and support specific instructions such as determination of the number of cycles executed by the processor; the value of a real time clock; and a way to determine the identity of the processor. For example, in the IA-32 architecture, the RDTSC (Read Time-Stamp Counter) instruction may be used to count basic processor cycles. The IA-32 RDMSR (Read from Model-Specific Register, or MSR) and a CPUID instruction may be used to determine various parameters about the processor's model, type and identity. These include CPU type, which in turn allows determination of frequency of operation specified at a specific bus speed from a table as specified in the IA-32 documentation. Furthermore, other fields in an IA-32 MSR such as the Processor Frequency Configuration field and Scalable Bus Speed fields may then be used in conjunction with the table to find the expected processor frequency.

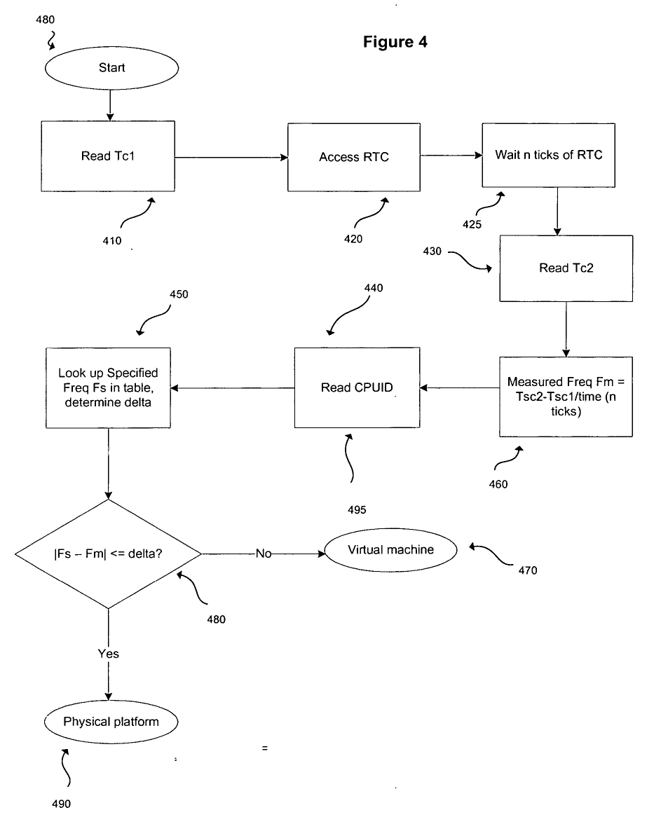

These instructions, or an equivalent set in a different architecture, may be used to detect a virtualized environment. In one such IA-32 embodiment the high level program of FIG. 3 may be implemented as a program using specific instructions of the IA-32 architecture as shown in FIG. 4. A program process to detect virtualization, 480, begins by the program first requesting a value from the processor on which it is executing for the total basic clock cycles executed, Tc1, at 410 using an instruction such as RDTSC. A real time clock (RTC) of the system is then accessed 420 and the process waits or loops for a known period of the real time clock, here, n ticks, 425. The program then reads the new current value for processor clock cycles executed, Tc2, 430. The difference between the two values divided by the time, or
(Tc2−Tc1)/n
yields a measured frequency, Fm, 460. Next the processor's identifying information is accessed, using a CPUID or a similar instruction at 495. This information may be provided as a set of register values in model specific registers (MSRs) in the processor, readable by the process 480. At least one or more of the acquired values may then be used to index into a predefined table published as part of the processor's specifications, 450, to yield a set of possible predetermined frequencies and tolerances for those frequencies. The program selects the specified frequency Fs, closest to the measured frequency Fm, at 450, and the associated specified range or tolerance in terms of drift or variation allowed for the processor, the value delta may be read from the table or be known from other data specified for the processor. The absolute value of the difference between Fs and Fm is then computed and compared to delta, 480. If it exceeds delta, the program is executing in a virtual machine or on a virtualized platform, 470; otherwise the platform is a non-virtualized, physical platform, 490.

The correctness of this processing relies on the likelihood that regardless of the actual method of virtualization used, the virtualized real time clock must be identical to the physical real time clock. Thus, even though a program accessing the real time clock as at 420 and 425 may be executing in a virtualized environment, the virtualized environment must provide direct access to the real time clock of the underlying system if the virtualized environment is to properly perform certain types of time-critical functions. In general, it may be assumed that a production quality virtualization system will not virtualize the real time clock as seen by a guest, but will instead provide direct access to the real time clock of the underlying system. This provides a window of access to the real physical machine for the guest that may be used as shown to detect virtualization. If a program executing as a guest in a virtual machine has access to a physical real time clock, it may compare the apparent frequency of the virtual processor presented by the virtual machine to the frequencies at which a physical processor identical to the virtual processor is specified to operate, as described above. Because of the overhead involved in virtualization, and because components of the virtual environment are emulated in software, the measured frequency of the virtual processor is very likely to vary over time, and generally to lie outside the normal expected range of variance of the operating frequency of a corresponding physical processor, and thus the virtualized nature of the platform may be detected by detecting excursions outside the normal variance of frequency. In general, if the virtualized processor is identical in model and specification to the underlying physical processor, the virtualized frequency will be lower than the actual frequency of the physical processor at a specific bus speed. Even if the virtualized processor is presented to a guest as a processor with a lower operating frequency than the underlying physical processor, e.g. by providing processor model information of a slower processor, the almost unavoidable variation in virtualized frequency caused by the basic nature of virtualization would still be detected with high probability by the processing described above. For higher accuracy, the process may be repeated several times to find a measured frequency that is outside a normal range.

The above embodiment is based on high level architectural features of the type available in an IA-32 processor, i.e. the availability of a clock cycle counter and a real time clock. However, the general flow of processing depicted in FIG. 1 does not rely on a specific architecture. Most modern processor based systems provide a way to measure actual operating frequency of the processor; and a way to determine the specified frequencies of operation for the processor, though the specific details may differ from those shown in FIG. 1 and from the IA-32 instructions referenced above. One of ordinary skill in the art would therefore appreciate that many alternative methods of determining if a measured frequency of a processor is close to a specified frequency of the processor may be employed in other embodiments.

Some embodiments may be provided as a software program product or software which may include a machine or machine-readable medium having stored thereon instructions which when accessed by the machine perform a process of the embodiment. In other embodiments, processes might be performed by specific hardware components that contain hardwired logic for performing the processes, or by any combination of programmed components and custom hardware components.

In the preceding description, for purposes of explanation, numerous specific details are set forth in order to provide a thorough understanding of the described embodiments, however, one skilled in the art will appreciate that many other embodiments may be practiced without these specific details.

Some portions of the detailed description above is presented in terms of algorithms and symbolic representations of operations on data bits within a processor-based system. These algorithmic descriptions and representations are the means used by those skilled in the art to most effectively convey the substance of their work to others in the art. The operations are those requiring physical manipulations of physical quantities. These quantities may take the form of electrical, magnetic, optical or other physical signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the description, terms such as “executing” or “processing” or “computing” or “calculating” or “determining” or the like, may refer to the action and processes of a processor-based system, or similar electronic computing device, that manipulates and transforms data represented as physical quantities within the processor-based system's storage into other data similarly represented or other such information storage, transmission or display devices.

In the description of the embodiments, reference may be made to accompanying drawings. In the drawings, like numerals describe substantially similar components throughout the several views. Other embodiments may be utilized and structural, logical, and electrical changes may be made. Moreover, it is to be understood that the various embodiments, although different, are not necessarily mutually exclusive. For example, a particular feature, structure, or characteristic described in one embodiment may be included within other embodiments.

Further, a design of an embodiment that is implemented in a processor may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, data representing a hardware model may be the data specifying the presence or absence of various features on different mask layers for masks used to produce the integrated circuit. In any representation of the design, the data may be stored in any form of a machine-readable medium. An optical or electrical wave modulated or otherwise generated to transmit such information, a memory, or a magnetic or optical storage such as a disc may be the machine readable medium. Any of these mediums may “carry” or “indicate” the design or software information. When an electrical carrier wave indicating or carrying the code or design is transmitted, to the extent that copying, buffering, or re-transmission of the electrical signal is performed, a new copy is made. Thus, a communication provider or a network provider may make copies of an article (a carrier wave) that constitute or represent an embodiment.

Embodiments may be provided as a program product that may include a machine-readable medium having stored thereon data which when accessed by a machine may cause the machine to perform a process according to the claimed subject matter. The machine-readable medium may include, but is not limited to, floppy diskettes, optical disks, DVD-ROM disks, DVD-RAM disks, DVD−RW disks, DVD+RW disks, CD-R disks, CD-RW disks, CD-ROM disks, and magneto-optical disks, ROMs, RAMs, EPROMs, EEPROMs, magnet or optical cards, flash memory, or other type of media/machine-readable medium suitable for storing electronic instructions. Moreover, embodiments may also be downloaded as a program product, wherein the program may be transferred from a remote data source to a requesting device by way of data signals embodied in a carrier wave or other propagation medium via a communication link (e.g., a modem or network connection).

Many of the methods are described in their most basic form but steps can be added to or deleted from any of the methods and information can be added or subtracted from any of the described messages without departing from the basic scope of the claimed subject matter. It will be apparent to those skilled in the art that many further modifications and adaptations can be made. The particular embodiments are not provided to limit the claimed subject matter but to illustrate it. The scope of the claimed subject matter is not to be determined by the specific examples provided above but only by the claims below

What is claimed is:

1. In a program executing on a processor based system, a method comprising:
obtaining one or more samples of the frequency at which a processor of the system is executing,
comparing each sample to at least one of a predetermined set of frequencies; and
determining whether the program is executing on a virtual machine based at least in part on of the result of the comparing.

2. The method of claim 1 wherein comparing each sample to the at least one of the predetermined set of frequencies further comprises determining if the sample is within a specified range of the at least one of the predetermined set of frequencies.

3. The method of claim 2 determining whether the program is executing in a virtual machine further comprises
determining that the program is not executing in a virtual machine if for each sample, the at least one of the predetermined set of frequencies is within a specified range of the sample; and
determining that the program is executing in a virtual machine, otherwise.

4. The method of claim 3 wherein the predetermined set of frequencies is selected based at least in part on an identifier reported by the processor in response to the execution of an identifying instruction.

5. The method of claim 3 further comprising obtaining a sample of the frequency at which the processor is executing by counting all clock cycles of the processor during an interval to obtain a tick count; measuring the duration of the interval on a real time clock of the processor; and computing the frequency by dividing the tick count by the duration.

6. The method of claim 5 wherein counting all clock cycles during an interval further comprises executing an instruction to obtain a first cycle count of the processor at the beginning of the interval; executing an instruction to obtain a second cycle count of the processor at the end of the interval; and obtaining the difference between the first cycle count and the second cycle count; and wherein measuring the duration of the interval on the real time clock further comprises executing an instruction to cause the program to wait for a time certain as determined by the real time clock of the processor.

7. A machine readable medium having stored thereon data that when accessed by a machine causes the machine to perform a method, the method comprising:
obtaining one or more samples of the frequency at which a processor of the system is executing,
comparing each sample to at least one of a predetermined set of frequencies; and
determining whether the program is executing on a virtual machine based at least in part on of the result of the comparing.

8. The machine readable medium of claim 7 wherein comparing each sample to the at least one of the predetermined set of frequencies further comprises determining if the sample is within a specified range of the at least one of the predetermined set of frequencies.

9. The machine readable medium of claim 8 wherein determining whether the program is executing in a virtual machine further comprises
determining that the program is not executing in a virtual machine if for each sample, the at least one of the predetermined set of frequencies is within a specified range of the sample; and
determining that the program is executing in a virtual machine, otherwise.

10. The machine readable medium of claim 9 wherein the predetermined set of frequencies is selected based at least in part on an identifier reported by the processor in response to the execution of an identifying instruction.

11. The machine readable medium of claim 9 wherein the method further comprises obtaining a sample of the frequency at which the processor is executing by counting all clock cycles of the processor during an interval to obtain a tick count;
measuring the duration of the interval on a real time clock of the processor; and
computing the frequency by dividing the tick count by the duration. In a program executing on a processor based system, a method comprising:
detecting a frequency at which a processor of the system is executing;
comparing the frequency to at least one of a predetermined set of frequencies; and
determining whether the program is executing on a virtual machine based at least in part on the result of the comparing.

12. The machine readable medium of claim 11 wherein counting all clock cycles during an interval further comprises executing an instruction to obtain a first cycle count of the processor at the beginning of the interval; executing an instruction to obtain a second cycle count of the processor at the end of the interval; and obtaining the difference between the first cycle count and the second cycle count; and wherein measuring the duration of the interval on the real time clock further comprises executing an instruction to cause the program to wait for a time certain as determined by the real time clock of the processor.

13. A system comprising:
a processor;
a storage having stored therein a program executable on the system, the program to obtain one or more samples of the frequency at which a processor of the system is executing,
compare each sample to at least one of a predetermined set of frequencies; and
determine whether the program is executing on a virtual machine based at least in part on of the result of the comparing.

14. The system of claim 13 wherein the program to compare each sample to the at least one of the predetermined set of frequencies further comprises instructions to determine if the sample is within a specified range of the at least one of the predetermined set of frequencies.

15. The system of claim 14 wherein the program to determine whether the program is executing in a virtual machine further comprises instructions
to determine that the program is not executing in a virtual machine if for each sample, the at least one of the predetermined set of frequencies is within a specified range of the sample; and
to determine that the program is executing in a virtual machine, otherwise.

16. The system of claim 15 wherein the predetermined set of frequencies is selected based at least in part on an identifier reported by the processor in response to the execution of an identifying instruction.

17. The system of claim 15 wherein the program further comprises instructions to obtain a sample of the frequency at which the processor is executing by counting all clock cycles of the processor during an interval to obtain a tick count;
to measure the duration of the interval on a real time clock of the processor; and
to compute the frequency by dividing the tick count by the duration.

18. The system of claim 17 wherein counting all clock cycles during an interval further comprises executing an instruction to obtain a first cycle count of the processor at the beginning of the interval; executing an instruction to obtain a second cycle count of the processor at the end of the interval; and obtaining the difference between the first cycle count and the second cycle count; and wherein the instructions to measure the duration of the interval on the real time clock further comprise instructions to cause the program to wait for a time certain as determined by the real time clock of the processor.

19. In a program executing on a machine, method comprising:
recording a first cycle count of a processor of the machine;
waiting for a predetermined number of ticks of a real time clock of the processor immediately following the recording of the first cycle count;
recording a second cycle count immediately following the waiting;
obtaining a measured frequency of the processor by dividing the difference between the second cycle count and the first cycle count by the time equivalent of the predetermined number of ticks;
obtaining an identifier of the processor;
looking up a table entry based on the identifier to determine a specified frequency of the processor;
comparing the specified frequency of the processor with the measured frequency of the processor; and
determining that the machine is a virtual machine if the difference between the specified frequency and the measured frequency exceeds a specified threshold value.
